(19) United States
(12) Patent Application Publication
(10) Pub. No.: US 2025/0349961 A1
(43) Pub. Date: Nov. 13, 2025

(54) INTEGRATED BATTERY IN COMPOSITE PANELS

(71) Applicant: Textron Innovations Inc., Providence, RI (US)

(72) Inventors: Vernon Weng-Yew Chang, Wichita, KS (US); Kyle Tidball, Wichita, KS (US); Engin Sabuncu, Wichita, KS (US); Amit Tamhane, Wichita, KS (US)

(21) Appl. No.: 18/658,387

(22) Filed: May 8, 2024

(51) Int. Cl. H01M 50/249; B64C 1/12; B64D 47/00; H01M 10/0585; H01M 10/42; H01M 10/44; H01M 50/102; H01M 50/112; H01M 50/124; H01M 50/202; H01M 50/204; H01M 50/231; H01M 50/296; H01M 50/298; H01M 50/528

(52) U.S. Cl. CPC H01M 50/249; B64C 1/12; B64D 47/00; H01M 10/0585; H01M 10/425; H01M 10/44; H01M 50/102; H01M 50/112; H01M 50/124; H01M 50/202; H01M 50/204; H01M 50/231; H01M 50/296; H01M 50/298; H01M 50/528; B64D 2221/00; H01M 2010/4271; H01M 2220/20

(57) ABSTRACT

An integrated battery includes a composite panel having one or more batteries disposed in an interior of the composite panel, and having a panel connector, wiring connecting each battery of the one or more batteries to the panel connector, one or more first cover layers disposed on a first side of the one or more batteries and at a first panel side of the composite panel, and one or more second cover layers disposed on a second side of the composite panel opposite the first panel side. The one or more first cover layers cover the wiring, and at least one of the one or more first cover layers or the one or more second cover layers covers the one or more batteries.

### TECHNICAL FIELD

The presented principles relate generally to a system and method for providing integrated batteries for vehicles, and, in particular embodiments, to a system and method for providing solid electrolyte batteries integrated into aircraft panels.

### BACKGROUND

Aircraft use batteries that are located throughout the entire aircraft to serve specific usage scenarios such as, for example, ground operations when the aircraft is not connected to a ground power source, ground operations before the engine-driven generators are brought online, in-flight when the battery is expected to operate while totally isolated from any aircraft electrical generation system, or in-flight emergency when all electrical generation is lost. Usage for ground operations may require a battery to provide electrical power to door lights, interior cockpit, passenger, or baggage lighting, exterior lights such as wing tip or strobe lights, or for avionics or radio systems. Using battery systems in-flight for generation system isolated power may require a battery to provide electrical power isolated from the aircraft electrical generation system for systems that may include portable equipment such as flash lights or as the primary energy source for an electric aircraft. Usage for in-flight emergencies may require a battery to provide electrical power to all equipment on the aircraft electrical bus when the aircraft generation system is lost.

While lithium-ion battery cells are significantly lighter than older traditional chemistries such as nickel-cadmium (NiCad) or lead-acid chemistries, the necessary protections and safety equipment required for use in aircraft tend to reduce the overall energy density benefits of a lithium-based chemistry. This effect may become more exaggerated if the lithium chemistry is a highly volatile chemistry. Likewise, most lithium-based chemistries currently use a liquid electrolyte, which may contribute substantially to cell weight.

### SUMMARY

An embodiment system includes a composite panel having one or more batteries disposed in an interior of the composite panel, where each battery of the one or more batteries is a solid state electrolyte battery, and further having a panel connector, wiring connecting each battery of the one or more batteries to the panel connector, one or more first cover layers disposed on a first side of the one or more batteries and at a first panel side of the composite panel, and one or more second cover layers disposed on a second side of the composite panel opposite the first panel side. The one or more first cover layers cover the wiring, and at least one of the one or more first cover layers or the one or more second cover layers covers the one or more batteries.

An embodiment vehicle includes at least one panel assembly mounted to the vehicle, where the at least one panel assembly is disposed at one of an interior or exterior surface of the vehicle. Each panel assembly of the at least one panel assembly includes one or more batteries disposed in an interior of the respective panel assembly, where each battery of the one or more batteries includes a solid state electrolyte, and further includes a panel connector, wiring connecting each battery of the one or more batteries to the panel connector, and one or more cover layers disposed on opposite sides of the one or more batteries and on opposite sides of the respective panel assembly. The one or more cover layers cover the wiring, and at least one of the one or more cover layers covers the one or more batteries.

An embodiment method includes providing one or more solid electrolyte batteries for a panel, providing a panel connector for the panel, electrically connecting the one or more solid electrolyte batteries to the panel connector, and forming the panel by forming one or more cover layers on opposite sides of the solid electrolyte batteries, where the one or more cover layers cover at least one side of the one or more solid electrolyte batteries.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of an integrated battery system according to some embodiments;

FIG. 2A-2B are a cross-sectional views of a solid electrolyte battery arrangements according to some embodiments;

FIGS. 3A-3D are cross-sectional views of integrated battery arrangements according to some embodiments;

FIG. 4 is a cross-sectional view of a solid electrolyte battery and wiring arrangement in a panel according to some embodiments;

FIG. 5 is a cross-sectional view of a solid electrolyte battery and wiring arrangement in a panel according to some embodiments;

FIG. 6 is a diagram illustrating an interior panel installation according to some embodiments;

FIGS. 7A-7B are is a cross-sectional views of a solid electrolyte battery and wiring arrangement for a panel according to some embodiments;

FIG. 8 is a cross-sectional view of an interior panel installation according to some embodiments; and

FIG. 9 is a flow diagram illustrating a method for making and using a panel with an integrated composite battery according to some embodiments.

### DETAILED DESCRIPTION OF ILLUSTRATIVE EMBODIMENTS

Solid state batteries use a solid electrolyte instead of a liquid electrolyte found in conventional lithium-ion batteries. The solid electrolyte can be in the form of a thin, rigid, molded ceramic layers or thin, flexible, formable polymer layers. These solid electrolyte layers have a form factor that is compatible with the construction of composite panels with multiple thin layers of woven fabrics and resin. Due to the use of inorganic electrolyte, some solid state battery chemistries have shown increased resistance to thermal runaway. In some cases, the inorganic electrolyte may reduce thermal runaway containment requirements and enable lighter weight battery systems. Likewise, with a solid electrolyte, cell weight may be reduced compared to that of a traditional liquid electrolyte. Solid-state based lithium batteries tend to be resistant to thermal runaway, creating the potential for a reduction in the required thermal runaway containment mechanism, reducing overall battery system weight, and leading to increased system energy density. Likewise, with a solid electrolyte, cell weight may be reduced compared to that of a traditional liquid electrolyte. However, due to accelerated cell degradation at high charge or discharge rates, solid state batteries tend to be suitable for lower discharge rate applications than traditional liquid or wet electrolyte lithium ion batteries. In order to take advantage of solid-state batteries for aircraft applications, lower discharge rate systems may be powered by solid electrolyte batteries. If the solid state battery is used in a low discharge current application, the solid state battery will be sized to a similar capacity of the existing battery. Similarly, if the solid state battery is used in a higher discharge current application, the solid state battery will be sized to a larger capacity than the existing battery so that the solid state battery's maximum discharge rate is not exceeded.

However, while weight is a significant consideration for any element used in an aircraft, space is also at a premium in smaller general aviation and transport category aircraft. Electrical energy storage on aircraft tends to add significant weight with current battery cells. In some cases, a fully certified battery for an aircraft can have less than 50% of the weight of the battery actually used for storing energy. The remaining weight provides structural support to the battery, provides thermal and electrical insulation, vibration and shock dampening, as well as provisions to fully contain a potential thermal runaway or explosion of combustible electrolyte gases emitted during a cell failure. Aircraft composite panels are built with multiple layers of woven fabric and bound together by a resin; in some structural applications, foam or a honeycomb core, is used to increase the rigidity of the panel. Solid state batteries consist of thin layers of cathode, such as cathode current collector and catholyte material, a solid state electrolyte which acts as both electrolyte and separator, and anode such as anode current collector and lithium metal as the anolyte material. Each of these elements can be built as a thin foil than can be placed within an aircraft composite panel to produce a multi-functional composite. These multi-functional composites can be used in existing aircraft structural applications, such as an interior floor panel, an interior seatback tray table, or an exterior surface fairing panel, non-structural applications such as an interior window shade, or interior façade, or the like. Integrating the functions of a solid state battery and a composite panel into a multi-functional composite, permits more efficient use of weight than the sum of the individual battery and composite panel.

The presented principles are directed to providing structures such as interior panels, or aircraft furniture, that act as solids state batteries or that have integrated solid electrolyte batteries, permitting the structures to be used to power emergency systems. For example, a divider panel between interior aircraft compartments or sections has traditionally been honeycomb core, solid core, or supported by an internal frame, but may be formed as, or house, solid electrolyte batteries. Traditional batteries use a liquid electrolyte. However, interior panel batteries may make use of a solid electrolyte. The solid electrolyte is an inorganic compound which tends to be very thermally stable, and thus, may eliminate the concern over the organic liquid electrolyte oxidizing and causing a thermal runaway. Therefore, the protections required around the battery can be dramatically reduced and the battery incorporated into composite panels while still ensuring a safe, reliable battery. The use of the solid electrolyte permits the battery to be part of the interior of the passenger compartment, as the solid electrolyte is generally safer than a liquid or wet electrolyte, and therefore, would not require the same level of thermal runaway prevention. The solid electrolyte battery uses a chemistry that is far less toxic in a fire, and thus, is less harmful to passengers in an emergency. For example, a laminated film solid-state battery cell may be incorporated as an additional ply into a composite laminate during layup. The laminate will then be cured, with the cured part functioning in a structural as well as energy storage capacity.

The use of solid-state batteries for a backup or emergency power application does not require repeated full charge and discharge cycles and, therefore, removes natural battery degradation due to charge cycling, which would otherwise limit the life of the panel structure. Additionally, an interior panel has some limited structural requirements. Any panel that is, or has, a solid-state battery would, therefore, inherit those limited structural requirements, but because of the nature of the solid electrolyte, and the composite construction, would be able to meet those structural requirements without risk of battery failure. Using a solid-state battery that meets flammability and toxicity criteria permits use for interior composites, as each battery cell would meet those requirements without additional protection. Solid-state batteries can also be co-manufactured with composites by choosing cell chemistry and composite materials that permit the battery cells to tolerate the processing parameters of composite manufacture, which may include usually high temperatures and pressures that may not be tolerated by wet electrolyte batteries.

The solid electrolyte batteries may be provided inside, or as part of, the interior panels so that the battery is hidden from passengers, and may have an electrical connector and wiring that permits the interior panel to be electrically connected to directly to an electrical loading device, to an aircraft's electrical power distribution system, or to both. Since the solid electrolyte batteries are presently limited in their ability to rapidly discharge current, having a low discharge rate, the electrical power distribution system may, for example, segregate circuits for low power draw systems from high draw systems, or segregate high priority systems, in-use systems, or the like. The electrical power distribution system may use the solid electrolyte battery systems to power the low power draw systems.

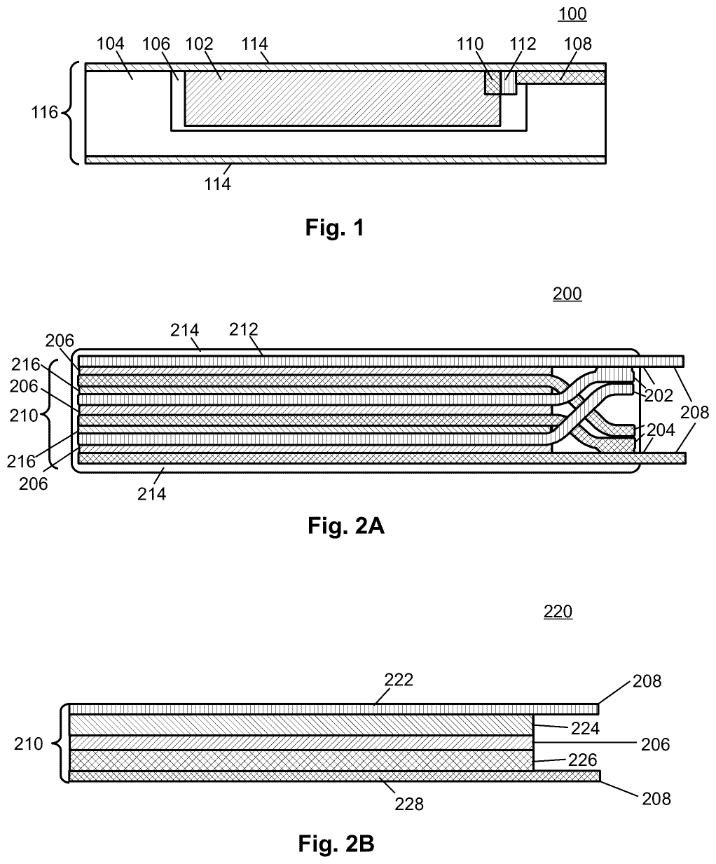

FIG. 1 is a cross-sectional view of an integrated battery system 100 according to some embodiments. A solid electrolyte battery 102 may be disposed in a composite panel 116. In some embodiments, the battery 102 may be disposed in a cavity 106 in a core 104 of the panel 116. The core 104 may be, for example, foam, a solid frame, a fiberglass, plastic or other synthetic material formed as a honeycomb, frame system, solid structure, or the like, or may be another material with a thickness sufficient to integrate the battery 102 into the panel 116. In other embodiments, the battery 102 may form the core of the panel 116, with the battery 102 providing thickness to the panel 116 between cover layers 114, and avoiding a core or other interior support or filler structure. Thus, the panel 116 may have one or more batteries 102 acting as a core of the panel 116.

In some embodiments, the panel 116 may have one or more cover layers 114 on each side of the core 104, or over the battery 102 where a core is not present. In the embodiment where the panel 116 has both the core 104 and the battery module 102, the battery module 102 may partially serve the function of the core. For example, a smaller, thinner, or lighter core may be used and the battery module 102 could assume the excess structural loads. The one or more cover layers 114 may cover the core 104 and enclose or encase the battery 102. In some embodiments, the cover layers 114 may include interior layers that act as structural layers, such as fiberglass or polymer layers that adhere to, and support, the core 104 to provide rigidity for the panel 116. For example, pre-impregnated (prepreg) material such as prepreg fiberglass or prepreg carbon fiber fabrics with a synthetic fabric and uncured resin may be provided on the core 104, and then cured, for example, by heating, application of ultraviolet (UV) light, chemical curing, or the like to cure the resin in the prepreg fabric. In some embodiments, the prepreg fabric cover layers 114 may be vacuum bagged against the core 104 and cured during the vacuum bagging. This causes the prepreg fabric to adhere to the core 104 and harden, stiffening the panel 116. In other embodiments, the cover layers 114 may be formed through molding, machining, or the like, and the core formed between the cover layers by, for example, injecting expanding foam, forming the cores around a core 104, or the like. In yet other embodiments, composite face sheets may be precured and then secondarily bonded to a core that contains the battery using an elevated temperature cure film adhesive or room temperature cure paste adhesive. This process may be especially useful if elevated temperature cure is a limiting factor. In other embodiments, batteries may be integrated into the structure during a resin transfer molding (RTM) or vacuum bag assisted RTM (VARTM) process. In this process, dry fabric reinforcements, a core and a battery are placed in a closed mold or a one sided layup mold and injected with resin. The resin then is cured at elevated or ambient temperature forming a composite sandwich panel with the integrated battery integrated. This process may be used instead of using prepreg materials due to provide ambient cure resin options.

Additionally, in some embodiments, the cover layers 114 may have one or more exterior layers, such as cloth, leather plastic panels, or the like, that are used for protective and decorative purposes. The exterior layers may be provided on the outside of the cover layers 114, covering the structural layers, so that the structural layers may be formed without concern for aesthetics, and so that the panel 116 may be produced with a customizable outer surface. In other embodiments, the panel 116 may be sandwich panel with a metal bonded structure having metallic facesheets with treatment, finishes, isolation, or the like, as necessary. Similar types of core, adhesives and battery integration can be used.

In some embodiments, the cover layers 114 on each side of the core 104 may be formed as a unitary structure so that the cover layers 114 encase the battery 102 within the core 104. In other embodiments, the cover layers 114 may be formed with openings aligned with the cavity 106 to permit access to the battery 102 for inspection or maintenance. In such an embodiment, the cover layers 114 may include access panels, doors, or the like.

In some embodiments, the panel 116 may have wiring 108 that connects the battery 102 to other batteries 102, and to aircraft wiring connected to the battery management system, battery charge source from the aircraft electrical bus, and the intended electrical loading device, for example, where the emergency lighting battery is directly connected to the emergency lights inside the cabin. The wiring 108 may have a wiring connector 112 that connects to a battery connector 110, such as a plug, or the like. In other embodiments, wiring 108 may be a bus bar, wire, or another conductor that is permanently connected to the battery 102. The wiring 108 may be disposed in a wiring recess, trench, or other wiring cavity formed in the core 104. In other embodiments, the wiring 108 may be disposed on the top surface of the core 104, and the cover layers 114 may retain the wiring 108 in place, with the wiring 108 between the core 104 and cover layers 114.

FIG. 2A is a cross-sectional view of a solid electrolyte battery arrangement 200 according to some embodiments. A solid electrolyte battery may have an electrode stack 210 with first electrodes 202 and second electrodes 204, with the first electrodes 202 disposed in an electrode stacking direction with the second electrodes 204. The electrode stack 210 may have electrodes 202, 204 exposed at exterior surfaces of the electrode stack 210. In some embodiments, each first electrode 202 may be paired with a second electrode 204 and electrolyte 206 layer to form a single cell. Each cell, with a pair of first and second electrodes 202, 204, may be separated by an isolation layer 216 that may, for example, be a non-permeable layer that isolates the different electrode 202, 204 pairs to prevent the cells from intermingling in the stack.

In some embodiments, the battery arrangement 200 may have a case 214 or other outer protective coating and may form exterior surfaces 212 of the battery. For example, the casing 214 may be an enclosure, protective layer, or the like formed from a polymer, metal, alloy, or other protective coating. In other embodiments, the battery arrangement 200 may omit the case 214, with the outer surfaces 212 of the battery formed by surfaces of one or more of the electrodes 202, 204. One or more of the first electrodes 202 and second electrodes 204 may form a contact 208 that may be used for electrical contract with exterior system elements such as connectors, wiring, or the like. The electrodes 202, 204 or contacts 208 may extend outside of the case 214, where present, for connection to the exterior system elements. Additionally, in some embodiments, the electrode pairs 202, 204 may be separated into discrete cells, with the casing 214 separately encapsulating each the electrode pair 202, 204 and acting as the isolation layer 216 between adjacent cells or electrode pairs 202, 204.

The first electrodes 202 and second electrodes 204 may be separated from adjacent electrodes 202, 204 by a solid electrolyte 206 such as a film, sheet, or the like made from a polymer or ceramic. In some embodiments, the first electrodes are anodes, and, for a solid electrolyte chemistry, may be metallic lithium. It should be understood that the first electrodes 202 are not limited to being the anode and the second electrodes 204 are not limited to being cathodes, as the first and second electrodes 202, 204, can be either electrode type. Additionally, while the first and second electrodes 202, 204 are shown as being solid materials, the first and second electrodes can each, or both, be coated electrodes, with a conductor coated with an anode or cathode material.

FIG. 2B is a cross-sectional view of a solid electrolyte battery arrangement 220 according to some embodiments. A solid electrolyte battery may have an electrode stack 210 with a single pair of electrodes, for example, with an anode current collector 222 disposed opposite a solid electrolyte 206 from a cathode current collector 228. A first interface layer 224, such as an anolyte, may be used to provide contact between the solid electrolyte 206 and the anode current collector 222. Similarly, a second interface layer 226, such as a catholyte, may be used to provide contact between the solid electrolyte 206 and the cathode current collector 228. The anode current collector 222 and cathode current collector 228 may each have portions that act as contacts 208, and may have an electrically insulating coating, casing, covering, or the like that permits multiple batteries be stacked to form battery banks or other battery arrangements.

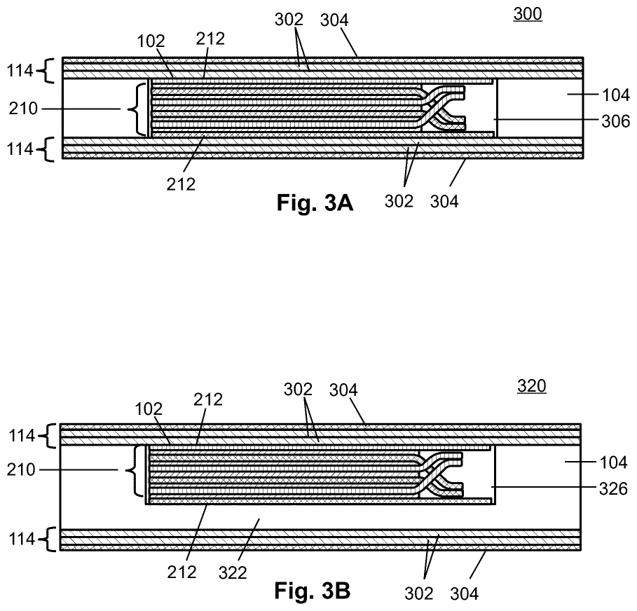

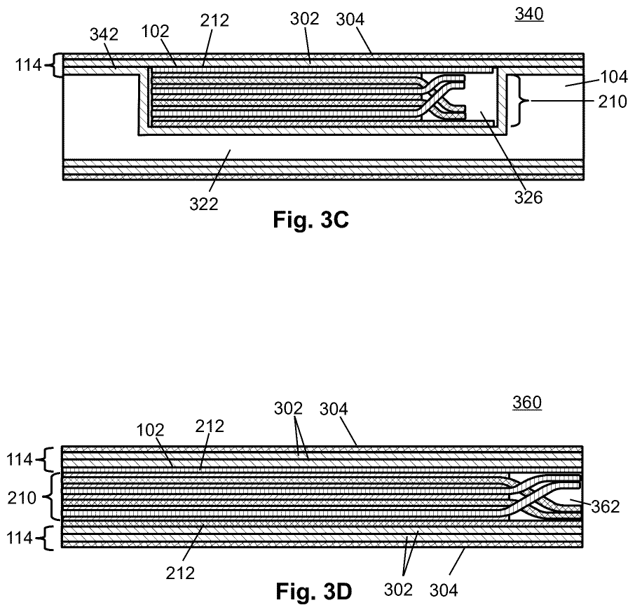

FIGS. 3A-3D are cross-sectional views of integrated battery arrangements according to some embodiments. In some embodiments, a solid electrolyte battery may use a pouch or hard casing. In other embodiments, the use of a solid electrolyte may permit battery arrangements without discrete casings, so that the composite serves as the discrete casing of the cell. Thus, the electrodes of the battery, or surfaces of the electrode stack, are in contact with surfaces of the panel, such as interior cavity surfaces, cover layers, or the like. This may reduce weight, particularly over metallic battery casings.

FIG. 3A is a cross-sectional view of an integrated battery arrangement 300 with a battery 102 in a through cavity 306 disposed in the core 104 according to some embodiments. A through cavity 306 may be a cavity that extends through the core 104 so the battery 102 is exposed on opposite sides of the core 104. In some embodiments, exterior surfaces of the electrode stack 210 may be exposed at the through cavity 306, and may, in some embodiments, be in direct contact with an inner layer 302 of the cover layers 114. In some embodiments, a first inner layer 302 may be in contact with, for example, exterior surfaces 212 of the battery 102, and one or more second inner layers 302 may be disposed on the first inner layers 302 and may be separated from the battery 102 by the first inner layers 302. An exterior layer 304 may be disposed on an inner layer 302 to cover and protect the inner layers 302.

FIG. 3B is a cross-sectional view of an integrated battery arrangement 320 with a battery 102 in a recessed cavity 326 disposed in the core 104 according to some embodiments. A recessed cavity 326 may be a cavity that extends into the core 104 but with the core 104 having a bottom portion 322 forming a bottom of the recessed cavity 326. Thus, the battery 102 may be exposed at a first side of the core 104. Additionally, in some embodiments, a first exterior surface 212 of the battery 102 may be in contact with the bottom portion 322 of the core 104, and a second exterior surface 212 of the battery 102 may be in contact with a first inner layer of the cover layer 114.

FIG. 3C is a cross-sectional view of an integrated battery arrangement 340 with a battery 102 in a recessed cavity 326 in the core 104 and between an inner layer 302 and a liner layer 342 of the cover layers 114 according to some embodiments. The core 104 may have a recessed cavity 326, and the liner layer 342 may line the surface of the recessed cavity 326. The liner layer 342 may conform to, and be attached to, the inner surface of the recessed cavity 326, with the bottom portion 322 of the core 104 supporting the liner layer 342, and with the liner layer 342 forming the surfaces of the recessed cavity 326. A first exterior surface 212 of the battery 102 may be in contact with a portion of the liner layer 342 that forms the recessed cavity 326 surfaces, and a second inner layer 302 may be in contact with a second exterior surface 212 of the battery 102. Thus, the liner layer 342 and inner layer 302 on one side of the panel may enclose the recessed cavity and encase the battery 102.

FIG. 3D is a cross-sectional view of an integrated battery arrangement 360 with a battery 102 disposed in a composite panel according to some embodiments. The integrated battery arrangement 360 may include a battery 102 that takes up a substantial part of the interior of the composite panel so that a core, or other filler structure is not needed. Thus, the battery 102 may act as an internal structure for the battery arrangement 360, with the electrode stack 210 acting to thicken up the composite panel.

In some embodiments, a first inner layer 302 may be in contact with a first exterior surface 212 of the battery 102 may be in contact with, and a second inner layer 302 may be in contact with a second exterior surface 212 of the battery 102. Thus, the first and second inner layers 302 of the panel may be disposed on opposite sides of the panel and may enclose or encase the battery 102. The battery 102 may substantially fill the space between opposing inner layers 302 so that the battery 102 provides the bulk of the thickness of the panel.

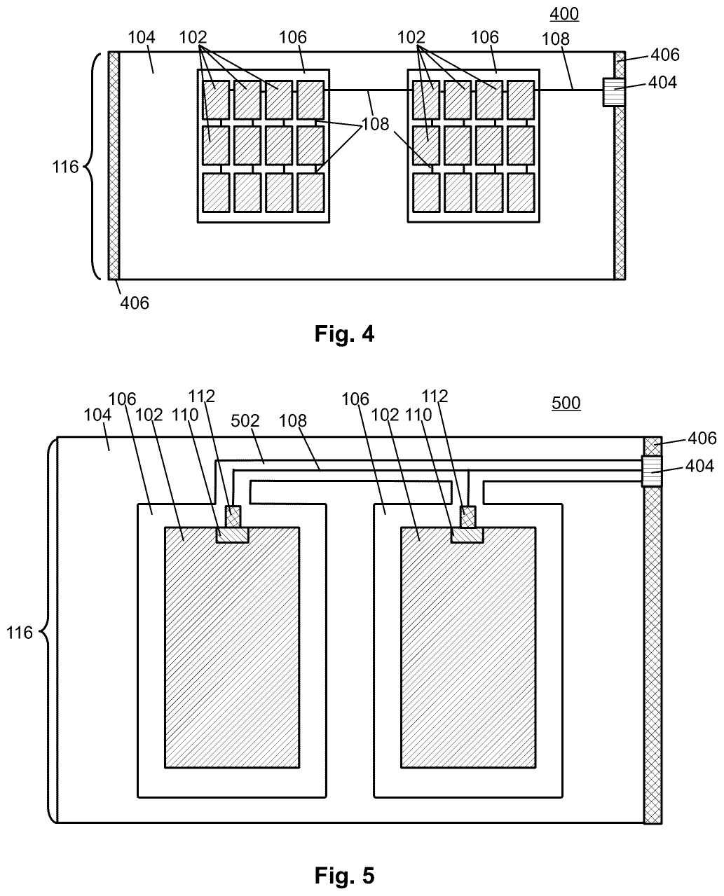

FIG. 4 is a cross-sectional view of a solid electrolyte battery and wiring arrangement 400 in a panel 116 according to some embodiments. A plurality of batteries 102 may be disposed in one or more recesses or cavities 106 in a core 104 of a panel 116. The batteries 102 may be connected to wiring 108 in series or parallel, or in an arrangement where batteries 102 are connected both in series and parallel to provide the desired voltage and battery capacity. The wiring 108 may extend through, or along, the core 104 to connect multiple batteries 102 or battery banks in the cavities 106. Additionally, the wiring 108 may connect to a panel connector 404 so that the panel may be installed in the interior or on the exterior of a vehicle, and may be connected directly to an electrical loading device or to an electrical power distribution system. In some embodiments, the panel may have edge structures 406 that may be end caps, solid strips, or other structures that cover the edges of the panel 116 that, in some embodiments, provide connection points for mounting the panel 116. In some embodiments, the panel connector 404 may be disposed in, attached to, or may be otherwise supported by an edge structure 406. For example, the panel connector 404 may be a plug mounted in a metal edge structure 406 that acts as a stiffener and mounting point for the panel 116. The plug-style panel connector 404 may be plugged into a vehicle plug of the aircraft when the panel 116 is installed. The panel connector 404 being mounted in the edge structure 406 may permit the panel connector 404 to remain hidden when the panel 116 is installed. For either an exterior or an interior panel installation, the panel connector 404 may be on the hidden side of the panel that is not visible to passengers. However, the panel connector 406 may also be on the visible side of the panel.

FIG. 5 is a cross-sectional view of a solid electrolyte battery and wiring arrangement 500 in a panel 116 according to some embodiments. One or more batteries 102 may be disposed in one or more cavities 106 in the core 104. Wiring 108 may include wiring connectors 112 that connect to battery connectors 110 of the batteries 102 to connect the batteries 102 to each other and to the panel connector 404. The wiring 108 may be disposed in wiring cavities 502 that are recesses or openings in the core 104, permitting the wiring 108 to lie under the cover layers. The wiring 108 may extend from each battery 102 to a panel connector 404 disposed at an edge of the panel 116. In some embodiments, the panel connector 404 may be attached to, or disposed in, the edge structure 406.

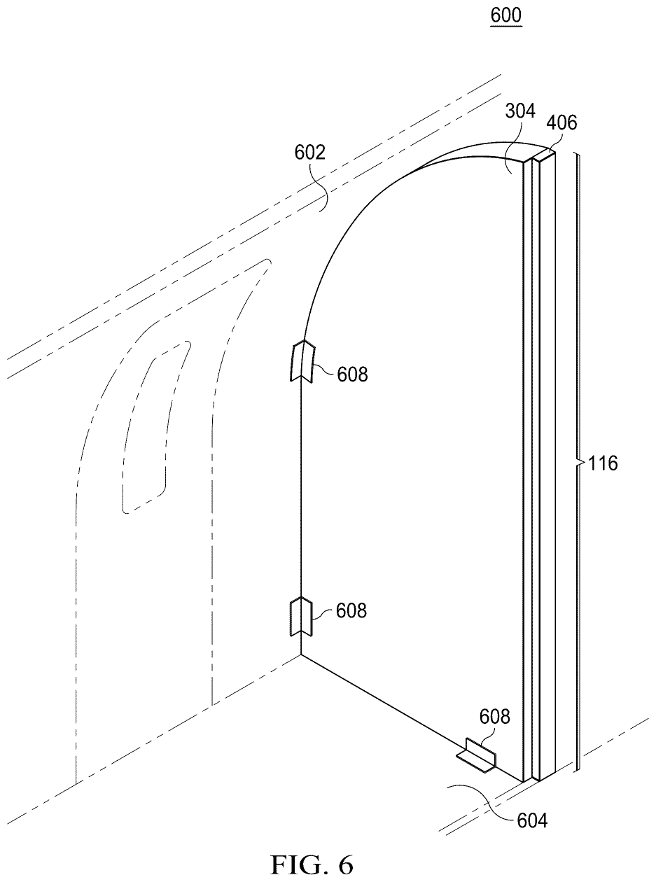

FIG. 6 is a diagram illustrating an interior panel installation 600 according to some embodiments. A panel 116 may be installed in an interior of a vehicle by mounting the panel 116 to a floor 604 of the vehicle interior. In some embodiments, the panel 116 may also be attached to a wall 602 or ceiling of the vehicle, and in embodiments where the vehicle is an aircraft, the panel 116 may be attached to a curved surface. The panel 116 may be attached to the interior surface of the vehicle, and may conform the interior surface. For example, in an aircraft where the body or fuselage of the aircraft is tubular, the interior surfaces of the aircraft may have a curved shape, and the panel 116 may have at least one curved edge that conforms to the wall 602 of the aircraft interior. Thus, the panel 116 may be sized to provide partitioning between sections of the interior cabin, and may, for example, be between 2 and 5 feet wide, and between about 4 and about 7 feet high, with a thickness in a range of about ½ inch to about 6 inches thick. For example, a panel in an interior cabin of a business jet may be about ½ inch thick.

The panel 116 may be attached substantially perpendicular to the wall 602 or floor 604 by, for example, mounting structure 608 such as brackets, brackets, clips, screws, tabs, pins, or the like. In some embodiments, the mounting structures 608 may be internal to the panel, for example, clips that attach to holes in the wall 602 of the interior. In other embodiments, the panel 116 may be mounted to the wall 602, for example, by external brackets, or the like, so that an exterior layer 304 or exterior surface of the panel 116 is exposed within the vehicle interior. In some embodiments, mounting the panel 116 to the wall may include attaching a plug or connector that is in, or extends through, the edge of the panel 116, or through the edge structure 406 to a connection point or aircraft connector prior to mounting the panel 116 to the wall 602.

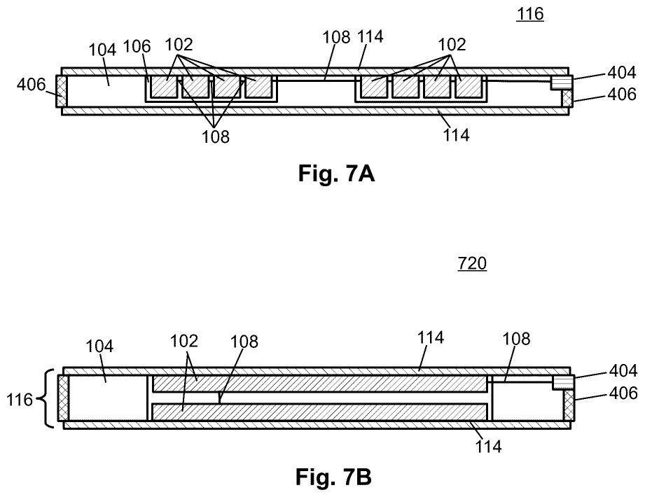

FIG. 7A is a cross-sectional view of a planar solid electrolyte battery and wiring arrangement for a panel 116 according to some embodiments. In some embodiments, the panel 116 may have a core 104 with one or more cavities extending at least partially through the core 104. In other embodiments, the core 104 may be omitted, so that the batteries 102 may act as an internal structure for the panel, with the batteries 102 providing a thickness for the composite panel 116.

One or more edge structure 406 may be disposed at opposite ends of the core 104. The edge structures 406 may be bonded or otherwise attached to the core 104, and may be in contact with one or more cover layers 114 disposed on each side of the core 104. The cover layers 114 may extend to at least partially cover faces of the edge structure 406 that face the same directions as the sides of the cores 104. In other embodiments, the cover layers 114 may completely cover the side surfaces of the edge structures 406 so that only a face at the end of the panel 116 are exposed. In other embodiments, the cover layers 114 may extend around the edges or edge faces of the edge structures 406 to completely cover the edge structures 406. One or more batteries 102 or battery assemblies may be disposed in the one or more cavities 106, or may completely fill the interior spaces of the panel 116, and may be connected to each other, and to a panel connector 404 by wiring 108. Additionally, one or more batteries may be arranged in a plane perpendicular to a longest axis of the panel 116, and may be connected in series, or in series, while being arranged in a planar fashion.

FIG. 7B is a cross-sectional view of a planar solid electrolyte battery and wiring arrangement 720 for a panel 116 according to some embodiments. In some embodiments, the panel 116 may have a core 104 with one or more batteries 102 in a stacked arrangement. In other embodiments, the core 104 may be omitted, so that the batteries 102 are stacked between cover layers 114 and acting as an internal structure for the panel 116, with the batteries 102 providing a thickness for the composite panel 116. In some embodiments, the batteries 102 may be connected in series, or in parallel, and multiple batteries may be stacked in a stacking direction substantially perpendicular to major surfaces of the panel 116 or cover layers 114.

Similar to the panel arrangement with batteries 102 in a planar arrangement, a panel 116 with batteries 102 in a stacked arrangement may have one or more edge structures 406 disposed at opposite ends of the core 104 or at edges of the panel 116. The cover layers 114 may extend to at least partially cover faces of the edge structure 406, may completely cover the side surfaces of the edge structures 406. In other embodiments, or may extend around the edges or edge faces of the edge structures 406. One or more batteries 102 or battery assemblies may be disposed in the one or more cavities 106 or between the cover layers 114, or may completely fill the interior spaces of the panel 116 and may be connected to each other, and to a panel connector 404 by wiring 108.

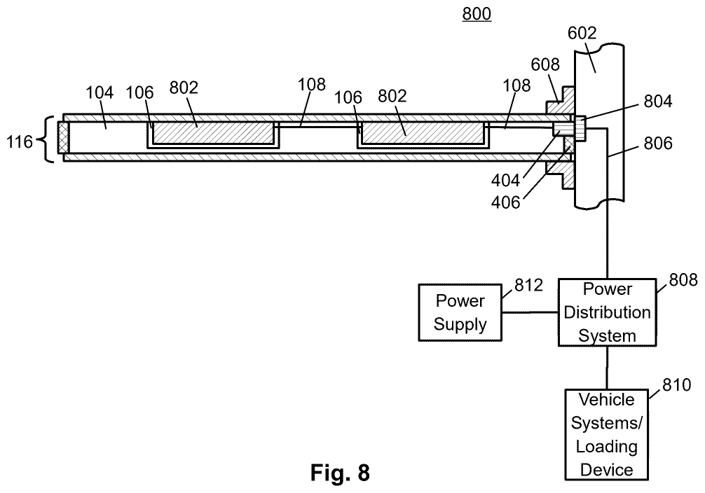

FIG. 8 is a cross-sectional view of an interior panel installation 800 according to some embodiments. A panel 116 may be attached to a wall 602 or other interior surface structure of a vehicle, and a first edge of the panel 116 may conform to the shape of the wall 602. In some embodiments, an edge structure 406 of the panel 116 contacts the wall 602, and the panel may be attached to the wall 602 or to a floor by mounting structures 608.

The panel 116 has one or more battery groups 802 disposed in a core 104 of the panel 116, and connected to a panel connector 404 by wiring 108 that extends through the core 104. When installed, the panel connector 404 is connected to a vehicle connector 804 that may pass through, be installed in or attached to, or may be supported by or connected to, the wall 602. Vehicle wiring 806 connects the battery group 802 to an electrical power distribution system 808 through the vehicle connector 804.

In some embodiments, one or more individual batteries may form a battery group 802, and each battery group 802 may be connected to other battery groups 802 that are disposed in separate cavities 106, or separately packaged within the panel 116. Each battery group 802 may have multiple batteries that are connected in series, in parallel, or both in series and parallel according to a desired voltage and capacity that will be provided by the individual battery groups 802. In other embodiments, the battery group 802 are individual batteries that are connected to each other to form a series of battery group 802. The wiring 108 may extend through the core 104, and may be covered by the one or more cover layers. The panel connector 404 may extend through, be connected to, be supported by, or be disposed in, one of the edge structures 406.

In some embodiments, the electrical power distribution system 808 may have a system, such as a power control system, that monitors an operational state of the vehicle to determine whether backup power for selected systems is required. For example, the electrical power distribution system 808 may determine, in response to a power signal from a main power system, such as a vehicle engine, engine electrical system such a generator or alternator, a propulsion battery, or the like, indicates failure of the main or primary power supply system. The electrical power distribution system may, in response to determining that electrical emergency power is needed, route power from the battery groups 802 in the panel 116, to one or more vehicle loading devices such as vehicle systems 810 identified as selected systems for backup panel supplied power. For example, a light emitting diode (LED) emergency exit power system may be a vehicle system 810 that is identified as a low power emergency system or system that needs backup power and can be supplied by a panel power supply. The emergency exit power system may be associated with the battery groups 802 providing emergency backup power. When the electrical power distribution system 808 determines that emergency power is needed, the electrical power distribution system 808 or power control system or the electrical power distribution system 808 may connect the battery groups 802 to the LED emergency exit power system. For example, the electrical power distribution system may be a switching system that detects an emergency conditions, such as a sudden deceleration, an emergency transmission or signal from a control system, cabin depressurization, or the like, and may turn on an emergency system such as LED emergency lighting system by connecting the emergency system Additionally, the electrical power distribution system 808 may further be connected to another load or system, such as a high draw system, and the electrical power distribution system 808 may connect the batteries to different vehicle systems 810 based on the power draw, priority, use, power demand, or another criterion, of the respective vehicle system 810.

In some embodiments, a battery management system may be provided to monitor an operational state of the batteries by providing protection functions, or provide other management or health related functions needed by the batteries or battery groups. For example, the battery management system may perform charge control, battery conditioning, battery monitoring, manage cell voltage balancing, temperature or current monitoring, connecting or disconnecting cells from their battery group, for example, to prevent overtemperature, or the like.

In some embodiments, the electrical power distribution system 808 may act as the battery management system to monitor an operational state of the batteries or battery groups, including monitoring the charge state, temperature, or other battery health related or operational information, of the battery groups 802 for the panel. In other embodiments, the battery management system may be separate from the panel and may be mounted, for example, in the vehicle outside of the panel or panels, and may monitor one or more panels batteries, battery groups, or the like.

In some embodiments, the battery management system may determine whether one or more of the battery groups 802 need to be charged, and may connect a power supply 812 to the battery groups 802 to charge the battery group 802, and may regulate the power supplied to the battery group 802. In some embodiments, the electrical power distribution system 808 may also monitor operational parameters of the battery groups 802, such as the charge or discharge rate of the battery groups 802, the capacity for charge that the battery groups 802 are capable of holding, battery temperature, a charge state, or the like. The battery management system may report data from monitoring the battery module operational parameters to a flight control system, instrument or instrument computer, or other system that reports or displays data, and the status of the batteries may be reported to a pilot, a maintenance facility, or a logging system.

In other embodiments, the electrical power distribution system 808 may act as a monitoring, management, and protection system, and may be connected to the battery modules 802 in parallel with a vehicle system 810 or another load. Thus, the battery modules 802 or panel 116 may be directly connected to a vehicle system 810 or load, and the electrical power distribution system 808 may provide monitoring, managing, protecting, and charging for the panel 116 while the panel provides power directly to the vehicle system 810 or another load. In yet other embodiments, the electrical power distribution system 808 may be omitted, with the panel 116 connected directly to the vehicle system 810 or other load, or with a switching or other intervening element between the electrical power distribution system 808 and vehicle system 810 or another load. When directly connected to the vehicle system or other load, the battery monitoring, managing, protection, and charging functions may be in a separate vehicle system 810 or electronics unit which may be installed in an externally accessible cavity of the panel 116 or installed on the vehicle outside the panel 116.

While the panel 116 is shown as being used as an interior divider for an aircraft, it should be understood that the panels may be used for any interior application. For example, the panel 116 may be used as a door, a panel for built-in fixtures such as a bathroom vanity, cabinet, or the like, or as a panel for furniture, seating, or the like. The panel can also be used for an exterior application where the panel may be part of an aerodynamic surface of the aircraft such as a wing panel, external fairing, or externally mounted aircraft system device such as a light, antenna, or another external system device.

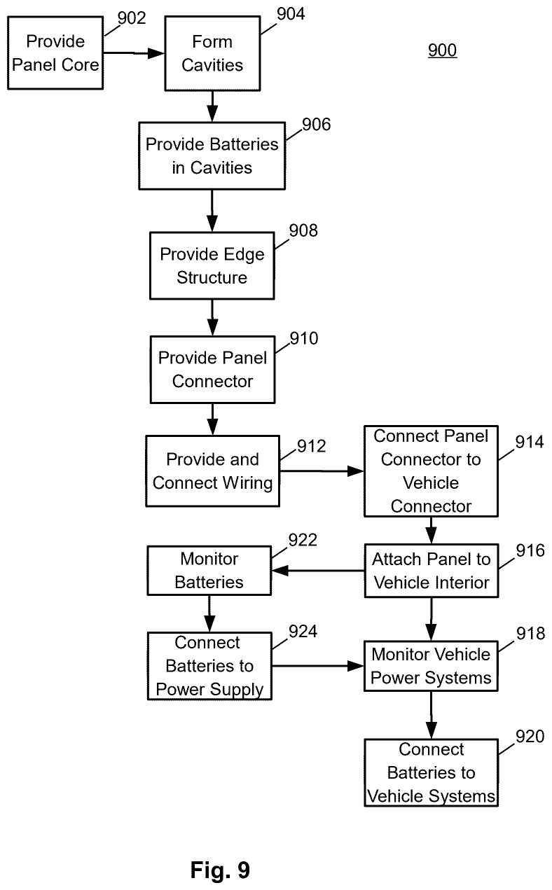

FIG. 9 is a flow diagram illustrating a method 900 for making and using a composite panel with an integrated solid electrolyte battery according to some embodiments. In block 902, a panel core is provided. In some embodiments, the panel core may be foam, a solid frame, a fiberglass, plastic or other synthetic material formed as a honeycomb, frame system, solid structure, or the like. The panel core may be cut, milled, molded, or otherwise formed to a desired shape. In some embodiments, the core may be omitted, and the integrated battery may fill most of the panel area so that there is no panel core needed.

In block 904, one or more cavities may be formed in the panel core. In some embodiments, the cavities may be openings or cavities for batteries, wiring, edge structures, connectors, support structures, or the like. Additionally, in some embodiments, the cavities may be formed as part of providing the panel core, for example, by molding the cavities into a foam or fiberglass panel core. In other embodiments, the cavities may be formed after the panel core is provided by, for example, routing, cutting, milling, or otherwise removing material from the panel core to form the cavities. In block 906, one or more solid electrolyte batteries are provided in the cavities. The batteries may be formed prior to placing them in the cavities, and may be attached or otherwise secured in the cavities. In some embodiments where the panel core is omitted, there is no cavity, and the composite plies may be formed or placed directly over the batteries, and the wiring between the battery and the panel connector. In block 908, an edge structure may optionally be provided and attached to the panel core. In some embodiments, the panel core may be omitted. In block 910, a panel connector may be provided, and disposed in the panel. Additionally, in some embodiments, electronics or systems for monitoring, controlling or charging the batteries may be installed into the panel. In block 912, wiring may be provided and connected to the batteries and to the panel connector. In some embodiments, the wiring may be flat wiring placed on a top or outer surface of the panel core. In other embodiments, the wiring may be round or dual conductor wiring, and may be placed in a wiring cavity formed in the panel core. In yet another embodiment, the wiring may be run through the edge structures along the edge of the panel to the panel connector. In some embodiments, the batteries may be provided with wiring between batteries of a battery module, and separate wiring may be provided to connect different battery modules to each other and to the panel connector. In block 914, the panel connector is connected to the vehicle connector to electrically connect the batteries to a power control system in the aircraft. In block 916, the panel is installed in or on the vehicle, and may be used as an interior or exterior panel or element.

Use or operation of the panel proceeds after installation of the panel in a vehicle. A system such as a power control system monitors vehicle power systems in block 918. The vehicle electrical power distribution system controllers may determine whether electrical power is needed from the battery, and in block 920, may connect the battery directly to a designated electrical loading device in the vehicle or to any electrical loading device connected to the vehicles' electrical power distribution system. Connecting the batteries to the electrical loading device, either directly or by way of the vehicle's electrical power distribution system permits the electrical loading device to draw power from the batteries integrated into the multi-functional composite panel. The electrical power distribution system controller and the battery management system may also monitor the batteries in block 922 to determine a charge state of the batteries, and to charge, maintain, condition, or others manage the batteries. In some embodiments, the battery electronics may be installed in an accessible cavity of the panel, or may be installed on the vehicle itself outside of the panel, and may be, for example, part of the vehicle power distribution system or may be a standalone system. In block 924, the electrical power distribution system controller may connect the batteries to a power supply such as aircraft generators, other batteries, external power source, or the like to charge the batteries. The battery management system may function as required to protect the battery from damage or from continued charge or discharge if the batteries are determined to be faulty or needing maintenance.

An embodiment system includes a composite panel having one or more batteries disposed in an interior of the composite panel, where each battery of the one or more batteries is a solid state electrolyte battery, and further having a panel connector, wiring connecting each battery of the one or more batteries to the panel connector, one or more first cover layers disposed on a first side of the one or more batteries and at a first panel side of the composite panel, and one or more second cover layers disposed on a second side of the composite panel opposite the first panel side. The one or more first cover layers cover the wiring, and at least one of the one or more first cover layers or the one or more second cover layers covers the one or more batteries.

In some embodiments, the composite panel further has a core disposed between the one or more first cover layers and the one or more second cover layers, where the one or more batteries are disposed in the core. In some embodiments, the core has one or more cavities disposed therein, where each battery of the one or more batteries is disposed in a cavity of the one or more cavities. In some embodiments, the wiring extends at least partially through a cavity of the one or more cavities. In some embodiments, the core has at least one through cavity extending from the first side of the composite panel to the second side of the core. In some embodiments, the core has at least one first cavity of the one or more cavities disposed at the first side of the core, and the core has a bottom portion disposed between the at least one first cavity and the second side of the core. In some embodiments, a first layer of the one or more first cover layers extends into the at least one first cavity and conforms to sides and a bottom of the at least one first cavity, a second layer of the one or more first cover layers covers the one or more batteries, and the first layer and second layer encase the one or more batteries. In some embodiments, the system further includes an edge structure disposed at an edge of the core, where the edge structure provides stiffness to the panel, and where the panel connector is disposed at the edge structure. In some embodiments, an exterior surface of an electrode stack of the one or more batteries directly contact a layer of the one or more first cover layers.

An embodiment vehicle includes at least one panel assembly mounted to the vehicle, where the at least one panel assembly is disposed at one of an interior or exterior surface of the vehicle. Each panel assembly of the at least one panel assembly includes one or more batteries disposed in an interior of the respective panel assembly, where each battery of the one or more batteries includes a solid state electrolyte, and further includes a panel connector, wiring connecting each battery of the one or more batteries to the panel connector, and one or more cover layers disposed on opposite sides of the one or more batteries and on opposite sides of the respective panel assembly. The one or more cover layers cover the wiring, and at least one of the one or more cover layers covers the one or more batteries.

In some embodiments, the vehicle further includes an electrical power distribution system electrically connected to the one or more batteries, and a first vehicle electrical load device connected to the electrical power distribution system, where an electrical power distribution system controller is configured to selectively connect the one or more batteries to the first vehicle electrical load device. In some embodiments, the vehicle further includes a power supply, where the electrical power distribution system is further configured monitor an operational state of the one or more batteries, and to charge the one or more battery from the power supply according to a charge state of the one or more batteries. In some embodiments, the vehicle further includes a first vehicle electrical load device connected directly to the one or more batteries. In some embodiments, each panel assembly of the at least one panel assembly further includes a core disposed in the interior of the respective panel assembly and between the one or more cover layers of the respective panel assembly, and where the one or more batteries of the respective panel assembly are disposed in the core. In some embodiments, the core has one or more cavities disposed therein, where each battery of the one or more batteries is disposed in a cavity of the one or more cavities. In some embodiments, an exterior surface of an electrode stack of the one or more batteries directly contacts a layer of the one or more cover layers.

An embodiment method includes providing one or more solid electrolyte batteries for a panel, providing a panel connector for the panel, electrically connecting the one or more solid electrolyte batteries to the panel connector, and forming the panel by forming one or more cover layers on opposite sides of the solid electrolyte batteries, where the one or more cover layers cover at least one side of the one or more solid electrolyte batteries.

In some embodiments, the method further includes electrically connecting the panel connector to a vehicle connector installed disposed at a wall of a vehicle interior, and mounting the panel to an interior surface of the vehicle. In some embodiments, the method further includes determining, by a power control system of the vehicle, whether emergency power is needed, and to connecting the one or more solid electrolyte batteries to one of a first vehicle system or a second vehicle system according to a power draw of the first vehicle system and second vehicle system and further in response to determining that emergency power is needed. In some embodiments, the method further includes monitoring, by a power control system of the vehicle, a charge state of the one or more solid electrolyte batteries and charging the one or more solid electrolyte batteries from a power supply of the vehicle according to the charge state of the one or more solid electrolyte batteries.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system, comprising:
a composite panel comprising:
one or more batteries disposed in an interior of the composite panel, wherein each battery of the one or more batteries is a solid state electrolyte battery;
a panel connector;
wiring connecting each battery of the one or more batteries to the panel connector;
one or more first cover layers disposed on a first side of the one or more batteries and at a first panel side of the composite panel; and
one or more second cover layers disposed on a second side of the composite panel opposite the first panel side;
wherein the one or more first cover layers cover the wiring; and
wherein at least one of the one or more first cover layers or the one or more second cover layers covers the one or more batteries.

2. The system of claim 1, wherein the composite panel further comprises a core disposed between the one or more first cover layers and the one or more second cover layers, wherein the one or more batteries are disposed in the core.

3. The system of claim 2, wherein the core has one or more cavities disposed therein, wherein each battery of the one or more batteries is disposed in a cavity of the one or more cavities.

4. The system of claim 3, wherein the wiring extends at least partially through a cavity of the one or more cavities.

5. The system of claim 3, wherein the core has at least one through cavity extending from the first side of the composite panel to the second side of the core.

6. The system of claim 3, wherein the core has at least one first cavity of the one or more cavities disposed at the first side of the core, and wherein the core has a bottom portion disposed between the at least one first cavity and the second side of the core.

7. The system of claim 6, wherein a first layer of the one or more first cover layers extends into the at least one first cavity and conforms to sides and a bottom of the at least one first cavity, wherein a second layer of the one or more first cover layers covers the one or more batteries, and wherein the first layer and second layer encase the one or more batteries.

8. The system of claim 2, further comprising an edge structure disposed at an edge of the core, wherein the edge structure provides stiffness to the panel, and wherein the panel connector is disposed at the edge structure.

9. The system of claim 1, wherein an exterior surface of an electrode stack of the one or more batteries directly contact a layer of the one or more first cover layers.

10. A vehicle, comprising:
at least one panel assembly mounted to the vehicle, wherein the at least one panel assembly is disposed at one of an interior or exterior surface of the vehicle;
wherein each panel assembly of the at least one panel assembly comprises:
one or more batteries disposed in an interior of the respective panel assembly, wherein each battery of the one or more batteries comprises a solid state electrolyte;
a panel connector;
wiring connecting each battery of the one or more batteries to the panel connector; and
one or more cover layers disposed on opposite sides of the one or more batteries and on opposite sides of the respective panel assembly;
wherein the one or more cover layers cover the wiring; and
wherein at least one of the one or more cover layers covers the one or more batteries.

11. The vehicle of claim 10, further comprising:
an electrical power distribution system electrically connected to the one or more batteries; and
a first vehicle electrical loading device connected to the electrical power distribution system;
wherein an electrical power distribution system controller is configured to selectively connect the one or more batteries to the first vehicle electrical loading device.

12. The vehicle of claim 11, further comprising a power supply;
wherein the electrical power distribution system is further configured to monitor an operational state of the one or more batteries, and to charge the one or more batteries from the power supply according to a charge state of the one or more batteries.

13. The vehicle of claim 10, further comprising a first vehicle electrical loading device connected directly to the one or more batteries.

14. The vehicle of claim 10, wherein each panel assembly of the at least one panel assembly further comprises a core disposed in the interior of the respective panel assembly and between the one or more cover layers of the respective panel assembly, and wherein the one or more batteries of the respective panel assembly are disposed in the core.

15. The vehicle of claim 14, wherein the core has one or more cavities disposed therein, wherein each battery of the one or more batteries is disposed in a cavity of the one or more cavities.

16. The vehicle of claim 9, wherein an exterior surface of an electrode stack of the one or more batteries directly contacts a layer of the one or more cover layers.

17. A method, comprising:
providing one or more solid electrolyte batteries for a panel;
providing a panel connector for the panel;
electrically connecting the one or more solid electrolyte batteries to the panel connector; and
forming the panel by forming one or more cover layers on opposite sides of the solid electrolyte batteries, wherein the one or more cover layers cover at least one side of the one or more solid electrolyte batteries.

18. The method of claim 17, further comprising:
electrically connecting the panel connector to a vehicle connector installed disposed at a wall of a vehicle interior; and
mounting the panel to an interior surface of the vehicle.

19. The method of claim 18, further comprising:
determining, by a power control system of the vehicle, whether emergency power is needed, and to connecting the one or more solid electrolyte batteries to one of a first vehicle system or a second vehicle system according to a power draw of the first vehicle system and second vehicle system and further in response to determining that emergency power is needed.

20. The method of claim 18, further comprising:
monitoring, by a power control system of the vehicle, a charge state of the one or more solid electrolyte batteries; and
charging the one or more solid electrolyte batteries from a power supply of the vehicle according to the charge state of the one or more solid electrolyte batteries.
